(19) United States
(12) Patent Application Publication
(10) Pub. No.: US 2022/0366717 A1
(43) Pub. Date: Nov. 17, 2022

(54) Sensor-based Bare Hand Data Labeling Method and System

(71) Applicant: QINGDAO PICO TECHNOLOGY CO., LTD., Qingdao (CN)

(72) Inventor: Tao WU, Qingdao (CN)

(21) Appl. No.: 17/816,412

(22) Filed: Jul. 30, 2022

Related U.S. Application Data
(63) Continuation of application No. PCT/CN2021/116299, filed on Sep. 2, 2021.

(30) Foreign Application Priority Data
Feb. 18, 2021 (CN) 202110190107.7

(51) Int. Cl. G06V 40/10; G06V 20/64; G06T 7/00; G06T 7/73; G06F 3/0346

(52) U.S. Cl. CPC G06V 40/11; G06V 20/647; G06T 7/0012; G06T 7/73; G06F 3/0346; G06T 2207/30008

(57) ABSTRACT

A sensor-based bare hand data labeling method and system are provided. The method comprises: performing device calibration processing on a depth camera and on one or more sensors respectively preset at one or more specified positions of a bare hand, so as to acquire coordinate transformation data; collecting a depth image of the bare hand by the depth camera, and collecting 6DoF data of one or more bone points; acquiring, based on the 6DoF data and the coordinate transformation data, three-dimensional position information of a preset number of bone points; determining two-dimensional position information of the preset number of bone points on the depth image based on the three-dimensional position information of the preset number of bone points; and labeling joint information on all of the bone points in the depth image according to the two-dimensional position information and the three-dimensional position information.

### CROSS REFERENCE

This application is a continuation of the PCT International Application No. PCT/CN2021/116299 filed on Sep. 2, 2021, which claims priority to Chinese Application No. 202110190107.7 filed on Feb. 18, 2021, the entirety of which is herein incorporated by reference.

### TECHNICAL FIELD

The present disclosure relates to the technical field of image labeling, and more particularly, to a sensor-based bare hand data labeling method and system.

### BACKGROUND

As the lightweight interaction of bare hand tracking technology in virtual reality (VR)/augmented reality (AR)/mixed reality (MR) experience scenes play a relatively important role, requirements for precision, delay and environmental compatibility stability of bare hand tracking are relatively high. In order to better solve this problem, most of the current mainstream solutions of bare hand tracking use an algorithm architecture based on artificial intelligence (AI for short). A large amount of image training data needs to be collected, data needs to be labeled on each image, then training and learning of a convolutional neural network is performed, and by means of multiple training and based on large data sets, finally a high-precision high-stability convolutional neural network model for bare hand tracking is acquired.

Currently, the precision and stability of an AI network model for bare hand tracking are closely related to the size of training data volume, the richness of scene environments corresponding to the training data, and the richness of bare hand postures. Accuracy and stability of a recognition rate of 95% or more is typically required, and a training data volume is at least 2 million images. At present, there are mainly two common training data collection and acquisition methods: one is to acquire training data by means of untity graphic image rendering and synthesis; and the other is to collect depth image data directly by means of a depth camera, that is, coordinates of key positions of each hand on each image are manually labeled, and then data collection and confirmation and correction of data labeling precision are further performed in a semi-supervised manner.

However, in the described two data collection methods, the labeling efficiency and quality of collected data and the richness of collection environment scene backgrounds have certain limitations, which wastes manpower and material resources, and thus a large amount of high-quality training data cannot be quickly acquired, thereby rendering that the trained AI network model does not reach an expected training precision.

### SUMMARY

In view of the described problems, the embodiments of the present disclosure provide a sensor-based bare hand data labeling method and system, which can solve the problems that limitation of current manual data labeling influences the precision of model training in a later period.

The embodiments of the present disclosure provide a sensor-based bare hand data labeling method, comprising: performing device calibration processing on a depth camera and on one or more sensors respectively preset at one or more specified positions of a bare hand, so as to acquire coordinate transformation data of the one or more sensors with respect to the depth camera; collecting a depth image of the bare hand by the depth camera, and collecting, by the one or more sensors, six degree of freedom (6DoF for short) data of one or more bone points where the one or more sensors of the bare hand corresponding to the depth image are located; acquiring, based on the 6DoF data and the coordinate transformation data, three-dimensional position information of a preset number of bone points of the bare hand with respect to coordinates of the depth camera; determining two-dimensional position information of the preset number of bone points on the depth image based on the three-dimensional position information of the preset number of bone points; and labeling joint information on all of the bone points in the depth image according to the two-dimensional position information and the three-dimensional position information.

In at least one exemplary embodiment, performing device calibration processing on a depth camera and on one or more sensors respectively preset at one or more specified positions of a bare hand, so as to acquire coordinate transformation data of the one or more sensors with respect to the depth camera comprises: acquiring intrinsic parameters of the depth camera by Zhang Zhengyou's calibration method; controlling a sample bare hand on which the one or more sensors are mounted to move, in a preset manner, within a preset range defined by distances from the depth camera; photographing a sample depth image of the sample bare hand by the depth camera, and acquiring, based on an image processing algorithm, two-dimensional coordinates of one or more bone points where the one or more sensors are located in the sample depth image; and acquiring coordinate transformation data between the depth camera and the one or more sensors based on the two-dimensional coordinates and a Perspective-n-Point (PNP) algorithm, wherein the coordinate transformation data comprises rotation parameters and translation parameters between the coordinate system of the depth camera and a coordinate system of the one or more sensors.

In at least one exemplary embodiment, the preset range is 50 cm to 70 cm from the depth camera.

In at least one exemplary embodiment, in cases where there are multiple sensors, the preset manner of movement of the sample bare hand comprises: the sample bare hand moves in a way that in each frame photographed by the depth camera, multiple positions, corresponding to the multiple sensors, on the sample bare hand are all able to be clearly imaged.

In at least one exemplary embodiment, acquiring three-dimensional position information of a preset number of bone points of the bare hand with respect to coordinates of the depth camera comprises: acquiring bone length data of each joint of each finger of the bare hand and thickness data of each finger of the bare hand; acquiring three-dimensional position information of a fingertip (TIP) bone point and a distal interphalangeal (DIP for short) bone point of each finger of the bare hand according to the bone length data, the thickness data and the coordinate transformation data; and acquiring three-dimensional position information of a proximal interphalangeal (PIP for short) bone point and a metacarpophalangeal (MCP for short) bone point of a corresponding finger of the bare hand based on the three-dimensional position information of the TIP bone point and the DIP bone point, and the bone length data.

In at least one exemplary embodiment, an acquisition formula of the three-dimensional position information of the TIP bone point of each finger is:

TIP=L(S)+d₁v₁+rv₂; and

an acquisition formula of the three-dimensional position information of the DIP bone point of each finger is:

TIP=L(S)+d₁v₁+rv₂;

wherein d₁+d₂=b, b represents bone length data between the TIP bone point and the DIP bone point, L(s) represents three-dimensional position information of a sensor at a fingertip position of the finger with respect to the coordinates of the depth camera, r represents half of the thickness data of the finger, v₁ represents a rotation component of 6DoF data of the fingertip position in a Y-axis direction, and v₂ represents a rotation component of 6DoF data of the fingertip position in a Z-axis direction.

In at least one exemplary embodiment, acquiring three-dimensional position information of a PIP bone point and an MCP bone point of a corresponding finger of the bare hand based on the three-dimensional position information of the TIP bone point and the DIP bone point and the bone length data comprises: acquiring a first norm ∥PIP−DIP∥ of a difference value between the PIP bone point and the DIP bone point based on the bone length data, and determining the three-dimensional position information of the PIP bone point based on the first norm and the three-dimensional position information of the DIP bone point; and acquiring a second norm ∥PIP−MDP∥ of a difference value between the PIP bone point and the MCP bone point based on the bone length data; and determining the three-dimensional position information of the MCP bone point based on the second norm and the three-dimensional position information of the PIP bone point.

In at least one exemplary embodiment, the preset number of bone points comprises 21 bone points, wherein the 21 bone points comprise three joint points and one fingertip point of each of five fingers of the bare hand, and one wrist joint point of the bare hand.

In at least one exemplary embodiment, joint information of the wrist joint point comprises: two-dimensional position information of a sensor at the wrist joint point on the depth image, and three-dimensional position information of 6DoF data of the sensor at the wrist joint point with respect to the coordinates of the depth camera.

In at least one exemplary embodiment, determining two-dimensional position information of the preset number of bone points on the depth image based on the three-dimensional position information of the preset number of bone points comprises: projecting on a corresponding depth image based on the three-dimensional position information of the preset number of bone points, and determining the two-dimensional position information of the preset number of bone points on the depth image.

In at least one exemplary embodiment, the one or more sensors respectively preset at one or more specified positions of the bare hand comprise: sensors provided at fingertip positions of five fingers of the bare hand, and a sensor provided at a back position of a palm center of the bare hand.

In at least one exemplary embodiment, the one or more sensors comprise one or more electromagnetic sensors or one or more optical fiber sensors.

The embodiments of the present disclosure provide a sensor-based bare hand data labeling system, comprising: a coordinate transformation data acquisition unit, configured to perform device calibration processing on a depth camera and on one or more sensors respectively preset at one or more specified positions of a bare hand, so as to acquire coordinate transformation data of the one or more sensors with respect to the depth camera; a depth image and 6DoF data acquisition unit, configured to collect a depth image of the bare hand by the depth camera, and collect, by the one or more sensors, 6DoF data of one or more bone points where the one or more sensors of the bare hand corresponding to the depth image are located; a three-dimensional position information acquisition unit, configured to acquire, based on the 6DoF data and the coordinate transformation data, three-dimensional position information of a preset number of bone points of the bare hand with respect to coordinates of the depth camera; a two-dimensional position information acquisition unit, configured to determine two-dimensional position information of the preset number of bone points on the depth image based on the three-dimensional position information of the preset number of bone points; and a joint information labeling unit, configured to label joint information on all of the bone points in the depth image according to the two-dimensional position information and the three-dimensional position information.

In at least one exemplary embodiment, the one or more sensors respectively preset at one or more specified positions of the bare hand comprise: sensors provided at fingertip positions of five fingers of the bare hand, and a sensor provided at a back position of a palm center of the bare hand.

In at least one exemplary embodiment, the coordinate transformation data acquisition unit is configured to: acquire intrinsic parameters of the depth camera by Zhang Zhengyou's calibration method; control a sample bare hand on which the one or more sensors are mounted to move, in a preset manner, within a preset range defined by distances from the depth camera; photograph a sample depth image of the sample bare hand by the depth camera, and acquire, based on an image processing algorithm, two-dimensional coordinates of one or more bone points where the one or more sensors are located in the sample depth image; and acquire coordinate transformation data between the depth camera and the one or more sensors based on the two-dimensional coordinates and a PNP algorithm, wherein the coordinate transformation data comprises rotation parameters and translation parameters between the coordinate system of the depth camera and a coordinate system of the one or more sensors.

In at least one exemplary embodiment, the three-dimensional position information acquisition unit is configured to: acquire bone length data of each joint of each finger of the bare hand and thickness data of each finger of the bare hand; acquire three-dimensional position information of a fingertip (TIP) bone point and a distal interphalangeal (DIP) bone point of each finger of the bare hand according to the bone length data, the thickness data and the coordinate transformation data; and acquire three-dimensional position information of a Proximal Interphalangeal (PIP) bone point and a Metacarpophalangeal (MCP) bone point of a corresponding finger of the bare hand based on the three-dimensional position information of the TIP bone point and the DIP bone point, and the bone length data.

In at least one exemplary embodiment, an acquisition formula of the three-dimensional position information of the TIP bone point of each finger is: TIP=L(S)+d₁v₁+rv₂; and an acquisition formula of the three-dimensional position information of the DIP bone point of each finger is: TIP=L(S)+d₁v₁+rv₂; wherein d₁+d₂=b, b represents bone length data between the TIP bone point and the DIP bone point, L(s) represents three-dimensional position information of a sensor at a fingertip position of the finger with respect to the coordinates of the depth camera, r represents half of the thickness data of the finger, v₁ represents a rotation component of 6DoF data of the fingertip position in a Y-axis direction, and v₂ represents a rotation component of 6DoF data of the fingertip position in a Z-axis direction.

In at least one exemplary embodiment, the three-dimensional position information acquisition unit is configured to acquire three-dimensional position information of a PIP bone point and an MCP bone point of a corresponding finger of the bare hand based on the three-dimensional position information of the TIP bone point and the DIP bone point and the bone length data in the following way: acquiring a first norm ∥PIP−DIP∥ of a difference value between the PIP bone point and the DIP bone point based on the bone length data, and determining the three-dimensional position information of the PIP bone point based on the first norm and the three-dimensional position information of the DIP bone point; and acquiring a second norm ∥PIP−MDP∥ of a difference value between the PIP bone point and the MCP bone point based on the bone length data; and determining the three-dimensional position information of the MCP bone point based on the second norm and the three-dimensional position information of the PIP bone point.

In at least one exemplary embodiment, the two-dimensional position information acquisition unit is configured to: project on a corresponding depth image based on the three-dimensional position information of the preset number of bone points, and determine the two-dimensional position information of the preset number of bone points on the depth image.

The embodiments of the present disclosure provide a non-transitory computer-readable storage medium on which a computer program is stored, and the computer program, when executed by a processor, implements the method of any of the preceding embodiments or exemplary embodiments.

By means of the described sensor-based bare hand data labeling method and system, a depth image of a bare hand is collected by a depth camera, meanwhile 6DoF data of one or more bone points where one or more sensors are located is collected by the one or more sensors, and then three-dimensional position information and two-dimensional position information of a preset number of bone points with respect to coordinates of the depth camera are acquired based on the 6DoF data and coordinate transformation data, and joint information is labeled on all bone points in the depth image according to the two-dimensional position information and the three-dimensional position information, which can ensure the efficiency and quality of data labeling and the richness of collection environment scene backgrounds, facilitating improvement of the precision of training an AI network model by using labeling information.

To achieve the described and related objects, one or more aspects of the present disclosure comprise features that will be explained in detail later. The following description and accompanying drawings illustrate certain exemplary aspects of the present disclosure in detail. However, these aspects merely indicate a part of the various ways in which the principles of the present disclosure can be employed. In addition, the present disclosure is intended to comprise all such aspects and equivalents thereof.

### BRIEF DESCRIPTION OF THE DRAWINGS

With reference to the following description taken in conjunction with the accompanying drawings, and along with comprehensive understanding of the present disclosure, other objects and results of the present disclosure will become more apparent and more readily understood. In the drawings:

FIG. 1 is a flowchart of a sensor-based bare hand data labeling method according to embodiments of the present disclosure;

FIG. 2 is a schematic diagram of bone length data measurement according to embodiments of the present disclosure;

FIG. 3 is a schematic diagram of a bone point model of a bare hand according to embodiments of the present disclosure;

FIG. 4 is a principle diagram of a sensor-based bare hand data labeling system according to embodiments of the present disclosure; and

FIG. 5 is a schematic diagram of an electronic apparatus according to embodiments of the present disclosure.

In all the drawings, the same reference signs designate similar or corresponding features or functions.

### DETAILED DESCRIPTION OF THE EMBODIMENTS

In the following description, for purposes of explanation, numerous specific details are set forth in order to provide a thorough understanding of one or more embodiments. However, it will be obvious that these embodiments may be implemented without these specific details. In other instances, for ease of description of one or more embodiments, well-known structures and devices are shown in a form of block diagrams.

In order to describe a sensor-based bare hand data labeling method and system in the present disclosure in detail, exemplary embodiments of the present disclosure will be described in detail with reference to the accompanying drawings.

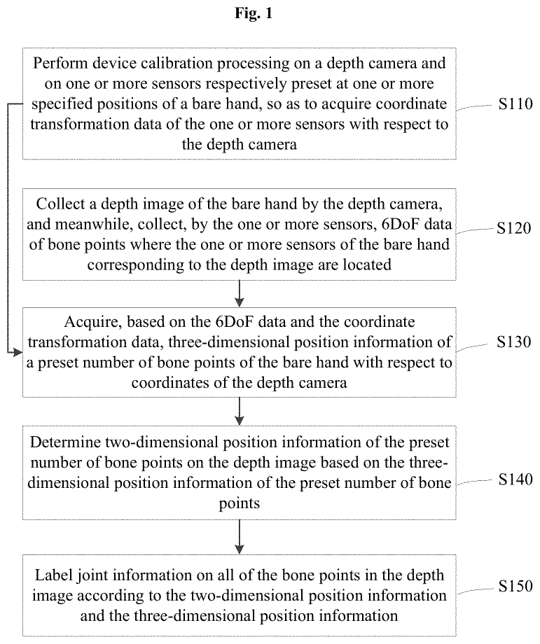

FIG. 1 illustrates a flowchart of a sensor-based bare hand data labeling method according to embodiments of the present disclosure.

As shown in FIG. 1, the sensor-based bare hand data labeling method in embodiments of the present disclosure comprises operations S110 to S150.

At S110, device calibration processing is performed on a depth camera and on one or more sensors respectively preset at one or more specified positions of a bare hand, so as to acquire coordinate transformation data of the one or more sensors with respect to the depth camera.

In the sensor-based bare hand data labeling method, the one or more sensors involved may be various types of sensors, such as one or more electromagnetic sensors or one or more optical fiber sensors which have stable data tracking quality. Specifically, six 6DoF electromagnetic sensors (modules), a signal transmitter and two hardware synchronous electromagnetic tracking units may be provided, and the six electromagnetic sensors may perform physical synchronization by using the two hardware synchronous electromagnetic tracking units, that is, it is ensured that the 6DoF data outputted by the six electromagnetic sensors are motion data generated at the same physical moment. In an application process, an outer diameter size of each sensor is less than 3 mm, and the smaller the size is, the better, which can enable image information of fingers wearing the one or more sensors cannot be captured by the depth camera, thereby ensuring the precision and accuracy of data acquisition.

In addition, a conventional ordinary camera may be used as the depth camera, and parameters of the depth image may be selected according to the camera or customized, for example, a collection frame rate of depth image data may be set to 60 Hz, and the resolution may be set to 640*480, and so on.

Specifically, the operation that device calibration processing is performed on a depth camera and on one or more sensors respectively preset at one or more specified positions of a bare hand, so as to acquire coordinate transformation data of the one or more sensors with respect to the depth camera comprises the following operations 1 to 4.

At operation 1, intrinsic parameters of the depth camera are acquired by Zhang Zhengyou's calibration method.

At operation 2, a sample bare hand on which the one or more sensors are mounted is controlled to move, in a preset manner, within a preset range defined by distances from the depth camera. The preset range may be set to be 50 cm to 70 cm from the depth camera.

Specifically, the preset manner of movement of the sample bare hand mainly includes: the sample bare hand moves in a way that in each frame photographed by the depth camera, multiple positions, corresponding to the multiple sensors, on the sample bare hand are all able to be clearly imaged. The situation that the sample bare hand shields the depth camera should be avoided as much as possible.

At operation 3, a sample depth image of the sample bare hand is photographed by the depth camera, and two-dimensional coordinates of one or more bone points where the one or more sensors are located in the sample depth image are acquired based on an image processing algorithm.

At operation 4, coordinate transformation data between the depth camera and the one or more sensors is acquired based on the two-dimensional coordinates and a PNP algorithm, wherein the coordinate transformation data comprises rotation parameters and translation parameters between the coordinate system of the depth camera and a coordinate system of the one or more sensors.

In an exemplary implementation, five 6DoF sensors are respectively worn on fingertip positions of five fingers of the sample bare hand according to a certain fixed manner, and one 6DoF sensor is worn at a back position of a palm center of the sample bare hand. Then, a sample depth image of the sample bare hand wearing the six sensors is photographed by the depth camera, and two-dimensional coordinates of position points (bone points) where the six sensors are located are acquired. Finally coordinate transformation data between the depth camera and the six sensors is determined according to the two-dimensional coordinates.

At S120, a depth image of the bare hand is collected by the depth camera, and the one or more sensors collects 6DoF data of one or more bone points where the one or more sensors of the bare hand corresponding to the depth image are located.

In an exemplary implementation, the depth image, collected by the depth camera, of the bare hand may synchronously acquire, in real time, six pieces of three-dimensional position information of 6DoF data of the six sensors with respect to the coordinates of the depth camera, and two-dimensional position information of six sensors on the depth image. It should be noted that operation S120 may be performed at the same time as operation S110, or the device calibration processing may be performed first, and then the depth image and the 6DoF data are collected.

At S130, three-dimensional position information of a preset number of bone points of the bare hand with respect to coordinates of the depth camera is acquired based on the 6DoF data and the coordinate transformation data.

In an exemplary implementation, the operation that three-dimensional position information of a preset number of bone points of the bare hand with respect to coordinates of the depth camera is acquired comprises the following operations 1 to 3.

At operation 1, bone length data of each joint of each finger of the bare hand and thickness data of each finger of the bare hand are acquired.

At operation 2, three-dimensional position information of a TIP bone point and a DIP bone point of each finger of the bare hand is acquired according to the bone length data, the thickness data and the coordinate transformation data.

At operation 3, three-dimensional position information of a PIP bone point and an MCP bone point of a corresponding finger of the bare hand is acquired based on the three-dimensional position information of the TIP bone point and the DIP bone point and the bone length data.

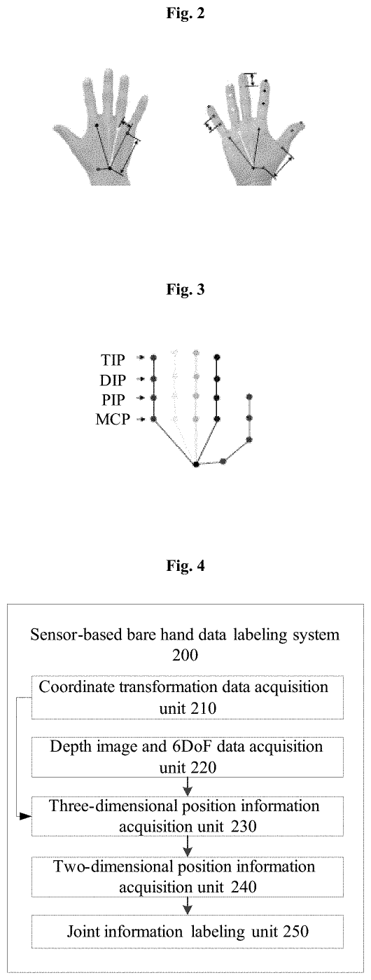

FIG. 2 is a schematic structure illustrating bone length data measurement according to embodiments of the present disclosure. FIG. 3 is a schematic diagram of a bone point model of a bare hand according to embodiments of the present disclosure.

As shown in FIGS. 2 and 3, the preset number of bone points in the embodiments of the present disclosure comprises 21 bone points, wherein the 21 bone points comprise three joint points and one fingertip point of each of five fingers of the bare hand, and one wrist joint point of the bare hand. Furthermore, in each finger, bone points in sequence from top to bottom are represented as a TIP bone point, a DIP bone point, a PIP bone point and an MCP bone point. According to a bionic rule, it is assumed that four bone points on each finger are all located on the same plane. FIG. 3 only shows a bone point structure of one finger.

In an exemplary embodiment of the present disclosure, an acquisition formula of the three-dimensional position information of the TIP bone point of each finger is:

TIP=L(S)+d₁v₁+rv₂;

in addition, an acquisition formula of the three-dimensional position information of the DIP bone point of each finger is:

TIP=L(S)+d₁v₁+rv₂;

wherein d₁+d₂=b, b represents bone length data between the TIP bone point and the DIP bone point, L(s) represents three-dimensional position information of a sensor at a fingertip position of the finger with respect to the coordinates of the depth camera, r represents half of the thickness data of the finger, v₁ represents a rotation component of 6DoF data of the fingertip position in a Y-axis direction, and v₂ represents a rotation component of 6DoF data of the fingertip position in a Z-axis direction.

Based on the above formulae, it can be concluded that after the three-dimensional position information of the TIP bone point and the DIP bone point is acquired, the three-dimensional position information of other bone points of the current finger can be further acquired according to the three-dimensional position information and the bone length data.

In an exemplary embodiment, the operation that three-dimensional position information of a PIP bone point and an MCP bone point of a corresponding finger of the bare hand is acquired based on the three-dimensional position information of the TIP bone point and the DIP bone point and the bone length data comprises the following operations 1 and 2.

At operation 1, a first norm ∥PIP−DIP∥ of a difference value between the PIP bone point and the DIP bone point is acquired based on the bone length data, then the three-dimensional position information of the PIP bone point is determined based on the first norm and the three-dimensional position information of the DIP bone point, and a second norm ∥PIP−MDP∥ of a difference value between the PIP bone point and the MCP bone point is acquired based on the bone length data. It should be noted that the process of determining the three-dimensional position information of the PIP bone point and the process of determining the second norm may be executed at the same time, and may also be executed in sequence, and the two are not necessarily dependent; and

At operation 2, the three-dimensional position information of the MCP bone point is determined based on the second norm and the three-dimensional position information of the PIP bone point.

According to the processing of the described operations, three-dimensional position information of the bone points of all the fingers of the bare hand can be acquired, that is, three-dimensional position information of 21 bone points of the bare hand is acquired.

It should be noted that as the position of the wrist joint point is special, the joint information of this bone point comprises: two-dimensional position information of a sensor at the wrist joint point on the depth image, and three-dimensional position information of 6DoF data of the sensor at the wrist joint point with respect to the coordinates of the depth camera acquired based on the coordinate transformation data. In other words, the two-dimensional position coordinates of the depth image corresponding to the three-dimensional position information of the sensor at the wrist joint of the bare palm and the three-dimensional position information with respect to the coordinate system of the depth camera are wrist joint information in the coordinate system of the depth camera.

At S140, two-dimensional position information of the preset number of bone points on the depth image is determined based on the three-dimensional position information of the preset number of bone points.

After three-dimensional position information of all bone points is acquired, two-dimensional position information corresponding to the three-dimensional position information can be acquired by performing projection on a corresponding depth image. At present, two-dimensional position information of one or more bone points where the one or more sensors are located can also be directly acquired on the depth image, and the present disclosure does not specifically limit various acquisition manners of the information.

At S150, joint information is labeled on all of the bone points in the depth image according to the two-dimensional position information and the three-dimensional position information.

In the sensor-based bare hand data labeling method of the embodiments of the present disclosure, two-dimensional coordinate information and three-dimensional coordinate information of each key point of data on each image can be directly acquired, which can improve the data labeling precision and labeling efficiency of depth data, and can also ensure the consistency of the labeling precision.

In order to ensure the accuracy of labeling data, in the sensor-based bare hand data labeling method of the embodiments of the present disclosure, six sensors stably collect the motion 6DoF data of the bare hand at 800 Hz, and drift and jitter of the 6DoF data of the six sensors should be avoided in the collection process. In addition, a high-performance PC is also needed to be connected to the depth camera and the six sensors, and is configured to respectively collect depth image data of the depth camera and motion data of six sensors of electromagnetic tracking units.

The high-performance PC collects 6DoF data of the six sensors and depth image data of the depth camera at the same time, and assigns one system timestamp to the 6DoF data and the depth image data, wherein the timestamps of the 6 pieces of 6DoF data are the same system timestamp. As the depth camera and the six sensors are not physically synchronized, the synchronization of two groups of data is achieved by looking up, according to a timestamp corresponding to each depth image, 6DoF data closest to the timestamp, and the maximum difference value between two timestamps is 0.7 ms, and thus it can be considered that the two groups of data are hand gesture motion data generated when the bare hand moves in a space at the same moment.

Corresponding to the described sensor-based bare hand data labeling method, the embodiments of the present disclosure provide a sensor-based bare hand data labeling system.

Specifically, FIG. 4 is a schematic logic illustrating a sensor-based bare hand data labeling system according to embodiments of the present disclosure. As shown in FIG. 4, the sensor-based bare hand data labeling system 200 comprises:

a coordinate transformation data acquisition unit 210, configured to perform device calibration processing on a depth camera and on one or more sensors respectively preset at one or more specified positions of a bare hand, so as to acquire coordinate transformation data of the one or more sensors with respect to the depth camera;

a depth image and 6DoF data acquisition unit 220, configured to collect a depth image of the bare hand by the depth camera, and collect, by the one or more sensors, 6DoF data of one or more bone points where the one or more sensors of the bare hand corresponding to the depth image are located;

a three-dimensional position information acquisition unit 230, configured to acquire, based on the 6DoF data and the coordinate transformation data, three-dimensional position information of a preset number of bone points of the bare hand with respect to coordinates of the depth camera;

a two-dimensional position information acquisition unit 240, configured to determine two-dimensional position information of the preset number of bone points on the depth image based on the three-dimensional position information of the preset number of bone points; and

a joint information labeling unit 250, configured to label joint information on all of the bone points in the depth image according to the two-dimensional position information and the three-dimensional position information.

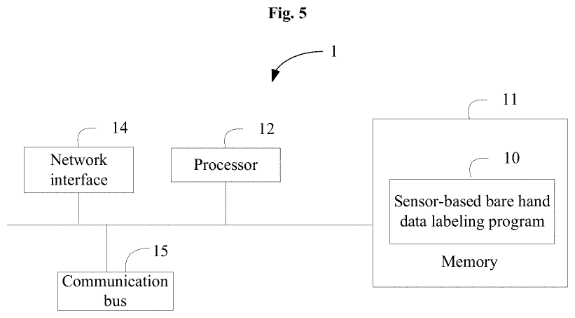

Correspondingly, the embodiments of the present disclosure provide an electronic apparatus. FIG. 5 shows a schematic structure of an electronic apparatus according to embodiments of the present disclosure.

As shown in FIG. 5, the electronic apparatus 1 in the embodiments of the present disclosure may be a terminal device with a computing function, such as a VR/AR/MR head-mounted all-in-one device, a server, a smart phone, a tablet computer, a portable computer, or a desktop computer. The electronic apparatus 1 comprises: a processor 12, a memory 11, a network interface 14, and a communication bus 15.

The memory 11 comprises at least one type of readable storage medium. The at least one type of readable storage medium may be a non-volatile storage medium such as a flash memory, a hard disk, a multimedia card and a card-type memory 11. In some embodiments, the readable storage medium may be an internal storage unit of the electronic apparatus 1, such as a hard disk of the electronic apparatus 1. In other embodiments, the readable storage medium may also be an external memory 11 of the electronic apparatus 1, for example, a plug-in hard disk, a smart media card (SMC), a secure digital (SD) card, a flash card, etc. which are equipped on the electronic apparatus 1.

In this embodiment, the readable storage medium of the memory 11 is typically used for storing a sensor-based bare hand data labeling program 10, etc. installed in the electronic apparatus 1. The memory 11 may also be used to temporarily store data that has been outputted or is to be outputted.

In some embodiments, the processor 12 may be a central processing unit (CPU), a microprocessor or other data processing chips, and is configured to run program codes or processing data stored in the memory 11, for example, execute the sensor-based bare hand data labeling program 10.

In some exemplary implementations, the network interface 14 may comprise a standard wired interface, a wireless interface (e.g., a Wi-Fi interface), and is usually configured to establish a communication connection between the electronic apparatus 1 and other electronic devices.

The communication bus 15 is configured to achieve connection communication between these components.

FIG. 5 only shows an electronic apparatus 1 having components 11-15, but it should be understood that not all of the illustrated components need to be implemented, and alternatively, more or fewer components may be implemented.

In some exemplary implementations, the electronic apparatus 1 may further comprise a user interface. The user interface may comprise an input unit such as a keyboard, a voice input apparatus such as a microphone which has a device having a voice recognition function, and a voice output apparatus such as audio device and an earphone. In some exemplary implementations, the user interface can further comprise a standard wired interface and a wireless interface.

In some exemplary implementations, the electronic apparatus 1 may further comprise a display, and the display may also be referred to as a display screen or a display unit. In some embodiments, the display may be an LED display, a liquid crystal display, a touch liquid crystal display, an organic light-emitting diode (OLED) touch device, etc. The display is configured to display information processed in the electronic apparatus 1, and is configured to display a visualized user interface.

In some exemplary implementations, the electronic apparatus 1 further comprises a touch sensor. A region provided by the touch sensor and for a user to perform a touch operation is referred to as a touch region. In addition, the touch sensor described herein may be a resistive touch sensor, a capacitive touch sensor, etc. Furthermore, the touch sensor not only comprises a contact-type touch sensor, but also comprises a proximity-type touch sensor. In addition, the touch sensor may be a single sensor, or may be a plurality of sensors arranged in an array, for example.

In the apparatus embodiment as shown in FIG. 1, the memory 11 serving as a computer storage medium may comprise an operating system and a sensor-based bare hand data labeling program 10; and the processor 12 implements the operations as shown in the sensor-based bare hand data labeling method and system when executing the sensor-based bare hand data labeling program 10 stored in the memory 11.

The exemplary embodiments of the computer-readable storage medium provided in the present disclosure are substantially the same as the exemplary embodiments of the described sensor-based bare hand data labeling method, system and electronic apparatus, and will not be repeated herein again. The method, system and electronic apparatus may also be referred to one another.

It should also be noted that in the text, the terms “comprise”, “include”, or any other variations thereof are intended to cover a non-exclusive inclusion, so that a process, an apparatus, an article, or a method that comprises a series of elements not only comprises those elements, but also comprises other elements that are not explicitly listed, or further comprises inherent elements of the process, the apparatus, the article, or the method. Without further limitation, an element defined by a sentence “comprising a . . . ” does not exclude other same elements existing in a process, an apparatus, an article, or a method that comprises the element.

The sequence number of the described embodiments of the present disclosure is only for description, but do not denote the preference of the embodiments. From the description of the described embodiments, a person having ordinary skill in the art would have been able to clearly understand that the method in the described embodiments may be implemented by using software and necessary general hardware platforms, and of course may also be implemented using hardware, but in many cases, the former is a better embodiment. Based on such understanding, the portion of the technical solution of the present disclosure that contributes in essence or to the prior art may be embodied in the form of a software product stored in a storage medium as described above (such as an ROM/RAM, a magnetic disk and an optical disc); and the storage medium comprises several instructions to cause a computer device (which may be a mobile phone, a computer, a server or a network device, etc.) to perform the method according to the various embodiments of the present disclosure.

The sensor-based bare hand data labeling method and system according to the present disclosure are described above by way of example with reference to the accompanying drawings. However, a person having ordinary skill in the art should understand that various improvements can be made to the sensor-based bare hand data labeling method and system provided by the present disclosure without departing from the present disclosure. Therefore, the scope of protection of the present disclosure should be determined by the content of the appended claims.

What is claimed is:

1. A sensor-based hand data labeling method, comprising:
performing device calibration processing on a depth camera and on one or more sensors respectively preset at one or more specified positions of a hand, so as to acquire coordinate transformation data of the one or more sensors with respect to the depth camera; collecting a depth image of the hand by the depth camera, and collecting, by the one or more sensors, six Degree of Freedom (6DoF) data of one or more bone points where the one or more sensors of the hand corresponding to the depth image are located;
acquiring, based on the 6DoF data and the coordinate transformation data, three-dimensional position information of a preset number of bone points of the hand with respect to coordinates of the depth camera;
determining two-dimensional position information of the preset number of bone points on the depth image based on the three-dimensional position information of the preset number of bone points; and
labeling joint information on all of the bone points in the depth image according to the two-dimensional position information and the three-dimensional position information.

2. The sensor-based hand data labeling method according to claim 1, wherein performing device calibration processing on a depth camera and on one or more sensors respectively preset at one or more specified positions of a hand, so as to acquire coordinate transformation data of the one or more sensors with respect to the depth camera comprises:
acquiring intrinsic parameters of the depth camera;
controlling a sample hand on which the one or more sensors are mounted to move, in a preset manner, within a preset range defined by distances from the depth camera;
photographing a sample depth image of the sample hand by the depth camera, and acquiring, based on an image processing algorithm, two-dimensional coordinates of one or more bone points where the one or more sensors are located in the sample depth image; and
acquiring coordinate transformation data between the depth camera and the one or more sensors based on the two-dimensional coordinates and a Perspective-n-Point (PNP) algorithm, wherein the coordinate transformation data comprises rotation parameters and translation parameters between the coordinate system of the depth camera and a coordinate system of the one or more sensors.

3. The sensor-based hand data labeling method according to claim 2, wherein the preset range is 50 cm to 70 cm from the depth camera.

4. The sensor-based hand data labeling method according to claim 2, wherein in cases where there are multiple sensors, the preset manner of movement of the sample hand comprises: the sample hand moves in a way that in each frame photographed by the depth camera, multiple positions, corresponding to the multiple sensors, on the sample hand are all able to be clearly imaged.

5. The sensor-based hand data labeling method according to claim 1, wherein acquiring three-dimensional position information of a preset number of bone points of the hand with respect to coordinates of the depth camera comprises:
acquiring bone length data of each joint of each finger of the hand and thickness data of each finger of the hand;
acquiring three-dimensional position information of a fingertip (TIP) bone point and a distal interphalangeal (DIP) bone point of each finger of the hand according to the bone length data, the thickness data and the coordinate transformation data; and
acquiring three-dimensional position information of a Proximal Interphalangeal (PIP) bone point and a Metacarpophalangeal (MCP) bone point of a corresponding finger of the hand based on the three-dimensional position information of the TIP bone point and the DIP bone point and the bone length data.

6. The sensor-based hand data labeling method according to claim 5, wherein an acquisition formula of the three-dimensional position information of the TIP bone point of each finger is:
TIP=L(S)+d₁v₁+rv₂; and
an acquisition formula of the three-dimensional position information of the DIP bone point of each finger is:
TIP=L(S)+d₁v₁+rv₂;
wherein d₁+d₂=b, b represents bone length data between the TIP bone point and the DIP bone point, L(s) represents three-dimensional position information of a sensor at a fingertip position of the finger with respect to the coordinates of the depth camera, r represents half of the thickness data of the finger, v₁ represents a rotation component of 6DoF data of the fingertip position in a Y-axis direction, and v₂ represents a rotation component of 6DoF data of the fingertip position in a Z-axis direction.

7. The sensor-based hand data labeling method according to claim 5, wherein acquiring three-dimensional position information of a PIP bone point and an MCP bone point of a corresponding finger of the hand based on the three-dimensional position information of the TIP bone point and the DIP bone point and the bone length data comprises:
acquiring a first norm ∥PIP−DIP∥ of a difference value between the PIP bone point and the DIP bone point based on the bone length data, and determining the three-dimensional position information of the PIP bone point based on the first norm and the three-dimensional position information of the DIP bone point; and acquiring a second norm ∥PIP−MDP∥ of a difference value between the PIP bone point and the MCP bone point based on the bone length data; and
determining the three-dimensional position information of the MCP bone point based on the second norm and the three-dimensional position information of the PIP bone point.

8. The sensor-based hand data labeling method according to claim 1, wherein the preset number of bone points comprises 21 bone points;
wherein the 21 bone points comprise three joint points and one fingertip point of each of five fingers of the hand, and one wrist joint point of the hand.

9. The sensor-based hand data labeling method according to claim 8, wherein joint information of the wrist joint point comprises:
two-dimensional position information of a sensor at the wrist joint point on the depth image, and three-dimensional position information of 6DoF data of the sensor at the wrist joint point with respect to the coordinates of the depth camera.

10. The sensor-based hand data labeling method according to claim 1, wherein determining two-dimensional position information of the preset number of bone points on the depth image based on the three-dimensional position information of the preset number of bone points comprises:
projecting on a corresponding depth image based on the three-dimensional position information of the preset number of bone points, and determining the two-dimensional position information of the preset number of bone points on the depth image.

11. The sensor-based hand data labeling method according to claim 1, wherein the one or more sensors respectively preset at one or more specified positions of the hand comprise:
sensors provided at fingertip positions of five fingers of the hand, and a sensor provided at a back position of a palm center of the hand.

12. The sensor-based hand data labeling method according to claim 1, wherein the one or more sensors comprise one or more electromagnetic sensors or one or more optical fiber sensors.

13. A sensor-based hand data labeling system, comprising a memory storing instructions and a processor in communication with the memory, wherein the processor is configured to execute the instructions to:
perform device calibration processing on a depth camera and on one or more sensors respectively preset at one or more specified positions of a hand, so as to acquire coordinate transformation data of the one or more sensors with respect to the depth camera;
collect a depth image of the hand by the depth camera, and collect, by the one or more sensors, six Degree of Freedom (6DoF) data of one or more bone points where the one or more sensors of the hand corresponding to the depth image are located;
acquire, based on the 6DoF data and the coordinate transformation data, three-dimensional position information of a preset number of bone points of the hand with respect to coordinates of the depth camera;
determine two-dimensional position information of the preset number of bone points on the depth image based on the three-dimensional position information of the preset number of bone points; and
label joint information on all of the bone points in the depth image according to the two-dimensional position information and the three-dimensional position information.

14. The sensor-based hand data labeling system according to claim 13, wherein the one or more sensors respectively preset at one or more specified positions of the hand comprise:
sensors provided at fingertip positions of five fingers of the hand, and a sensor provided at a back position of a palm center of the hand.

15. The sensor-based hand data labeling system according to claim 13, wherein the processor is configured to execute the instructions to:
acquire intrinsic parameters of the depth camera;
control a sample hand on which the one or more sensors are mounted to move, in a preset manner, within a preset range defined by distances from the depth camera;
photograph a sample depth image of the sample hand by the depth camera, and acquire, based on an image processing algorithm, two-dimensional coordinates of one or more bone points where the one or more sensors are located in the sample depth image; and
acquire coordinate transformation data between the depth camera and the one or more sensors based on the two-dimensional coordinates and a Perspective-n-Point (PNP) algorithm, wherein the coordinate transformation data comprises rotation parameters and translation parameters between the coordinate system of the depth camera and a coordinate system of the one or more sensors.

16. The sensor-based hand data labeling system according to claim 13, wherein the processor is configured to execute the instructions to:
acquire bone length data of each joint of each finger of the hand and thickness data of each finger of the hand;
acquire three-dimensional position information of a fingertip (TIP) bone point and a distal interphalangeal (DIP) bone point of each finger of the hand according to the bone length data, the thickness data and the coordinate transformation data; and
acquire three-dimensional position information of a Proximal Interphalangeal (PIP) bone point and a Metacarpophalangeal (MCP) bone point of a corresponding finger of the hand based on the three-dimensional position information of the TIP bone point and the DIP bone point, and the bone length data.

17. The sensor-based hand data labeling system according to claim 16, wherein an acquisition formula of the three-dimensional position information of the TIP bone point of each finger is:
TIP=L(S)+d₁v₁+rv₂; and
an acquisition formula of the three-dimensional position information of the DIP bone point of each finger is:
TIP=L(S)+d₁v₁+rv₂;
wherein d₁+d₂=b, b represents bone length data between the TIP bone point and the DIP bone point, L(s) represents three-dimensional position information of a sensor at a fingertip position of the finger with respect to the coordinates of the depth camera, r represents half of the thickness data of the finger, v₁ represents a rotation component of 6DoF data of the fingertip position in a Y-axis direction, and v₂ represents a rotation component of 6DoF data of the fingertip position in a Z-axis direction.

18. The sensor-based hand data labeling system according to claim 16, wherein the processor is configured to execute the instructions to acquire three-dimensional position information of a PIP bone point and an MCP bone point of a corresponding finger of the hand based on the three-dimensional position information of the TIP bone point and the DIP bone point and the bone length data in the following way:
acquiring a first norm ∥PIP−DIP∥ of a difference value between the PIP bone point and the DIP bone point based on the bone length data, and determining the three-dimensional position information of the PIP bone point based on the first norm and the three-dimensional position information of the DIP bone point; and acquiring a second norm ∥PIP−MDP∥ of a difference value between the PIP bone point and the MCP bone point based on the bone length data; and
determining the three-dimensional position information of the MCP bone point based on the second norm and the three-dimensional position information of the PIP bone point.

19. The sensor-based hand data labeling system according to claim 13, wherein the processor is configured to execute the instructions to:
project on a corresponding depth image based on the three-dimensional position information of the preset number of bone points, and determine the two-dimensional position information of the preset number of bone points on the depth image.

20. A non-transitory computer-readable storage medium, comprising a computer program stored thereon, wherein the computer program, when executed by a processor, implements the method according to claim 1.
